(19) United States
(12) Patent Application Publication
(10) Pub. No.: US 2004/0241513 A1
(43) Pub. Date: Dec. 2, 2004

(54) INTEGRATED RECUPREATOR AND BURNER FOR FUEL CELLS

(75) Inventors: Farrokh Issacci, Playa del Rey, CA (US); Peter Weixiang Zheng, Rancho Palo Verdes, CA (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 10/250,025

(22) Filed: May 29, 2003

(51) Int. Cl. H01M 8/04; H01M 8/06

(52) U.S. Cl. 429/26; 429/20

(57) ABSTRACT

A fuel cell system for converting a first flow and a second flow to electricity, a first spent flow, and a second spent flow. The fuel cell system may include a chamber for combusting the first spent flow and the second spent flow to produce heat and a pathway for the first flow. The pathway may be positioned about the chamber for heat exchange therewith.

### BACKGROUND OF INVENTION

1. Technical Field

The present invention relates generally to fuel cell systems and more particularly relates to a fuel cell with an integrated air preheater and tail gas burner.

2. Background of the Invention

Fuel cells electrochemically react fuels with oxidants to generate electricity. A fuel cell generally includes a cathode material, an electrolyte material, and an anode material. The electrolyte may be a non-porous material positioned between the cathode and the anode materials. The fuel and the oxidant typically are gases that continually flow about the anode, the cathode, and the electrolyte through separate passageways. A fuel gas may be hydrogen, a short-chain hydrocarbon, or a gas containing a desired chemical species in some form. An oxidant may be an oxygen-containing gas, or quite commonly, air. The fuel and the oxidant typically are pre-heated before being fed to the electrolyte.

A common fuel cell is a solid oxide fuel cell (“SOFC”). A SOFC uses a solid electrolyte for power generation. The solid electrolyte may be an ion-conducting ceramic or a polymer membrane. For example, the electrolyte may be a non-conductive ceramic, such as a dense yttria-stabilized zirconia (YSZ) membrane. The anode may be a nickel/YSZ cermet and the cathode may be a doped lanthanum manganite.

The electrochemical conversion occurs at or near the three-phase boundary of each electrode (the cathode and the anode) and the electrolyte. The fuel is electrochemically reacted with the oxidant to produce a direct current electrical output. The anode or the fuel electrode enhances the rate at which the electrochemical reaction occurs on the fuel side. The cathode or the oxidant electrode functions similarly on the oxidant side. The electrochemical reaction between the fuel and the oxidant produces electrical energy, spent fuel, and oxidant exhaust. This conversion of fuel and oxidant to electricity also produces heat, particularly at high current-power densities.

To achieve higher voltages for a specific application, the individual electrochemical cells may be connected in series to form a fuel cell stack. To achieve higher currents, individual cells may be connected in parallel. The electrical connection between the cells may be achieved by the use of an electrical interconnect between the cathode and the anode of adjacent cells. The electrical interconnect also may provide for passageways for oxygen to flow pass the cathode and fuel to flow pass the anode. Ducts or manifolds generally also are used to conduct the fuel and the oxidant into and out of the stack.

The heat produced in the reaction generally should be removed from the stack to maintain the fuel cells at an efficient operating temperature. The hot exhaust gas from the stack may be further combusted and/or fed to one or more heat exchangers. For example, the incoming fuel and/or the incoming oxidant may be preheated such that the gases enter the stack at higher, more efficient temperatures. Further, the incoming fuel flow may be processed with air and/or steam before entry into the stack. The exhaust gases also may be used to heat the air or to heat a water stream into steam. The more efficiently the spent gases may be reused in the system may have a significant impact on the efficiency of the system as a whole.

### SUMMARY OF INVENTION

The present invention thus provides a fuel cell system for converting a first flow and a second flow to electricity, a first spent flow, and a second spent flow. The fuel cell system may include a chamber for combusting the first spent flow and the second spent flow to produce heat and a pathway for the first flow. The pathway may be positioned about the chamber for heat exchange therewith. The first flow may include a flow of oxidant or fuel and the first spent flow may include a flow of spent oxidant or spent fuel.

A further embodiment of the present invention may provide for a fuel cell system for converting a flow of fuel and a flow of oxidant to electricity, a spent fuel flow, and a spent gas flow. The fuel cell system may include a chamber for combusting the spent fuel flow and the spent oxidant flow to produce heat and a pathway for the flow of oxidant. The pathway may be positioned about the chamber for heat exchange between the heat produced in the chamber and the flow of oxidant in the pathway.

A further embodiment of the present invention may provide for a fuel cell system for converting a first flow and a second flow to electricity, a first spent flow, and a second spent flow. The system may include an inner chamber for combusting the first spent flow and the second spent flow to produce heated exhaust gases. The inner chamber may include a side wall and an end wall. The side wall may include a number of apertures therein for the heated exhaust gases to flow therethrough. The system also may have a pathway for the first flow. The pathway may be positioned about the inner chamber for heat exchange with the heated exhaust gases. The system also may have an outer chamber to direct the flow of the heated exhaust gases.

A method of the present invention may provide for heating a flow of oxidant to be used in a fuel cell system producing electricity, a spent fuel flow, and a spent gas flow. The method may include combusting the spent fuel flow and the spent oxidant flow to produce heat, surrounding the combustion with the flow of oxidant, and heating the flow of oxidant.

These and other features of the present invention will become apparent upon review of the following detailed description when taken in conjunction with the drawings and the appended claims.

### BRIEF DESCRIPTION OF DRAWINGS

FIG. 1 is a schematic view of a solid oxide fuel cell system.

FIG. 2 is a schematic view of an alternative solid oxide fuel system.

FIG. 3 is a cross-sectional view of an integrated recuperator/combustor of the present invention.

FIG. 4 is a cross-sectional view of an alternative embodiment of the integrated recuperator/combustor of the present invention.

FIG. 5 is a cross-sectional view of an alternative embodiment of the integrated recuperator/combustor of the present invention.

FIG. 6 is a cross-sectional view of an alternative embodiment of the integrated recuperator/combustor of the present invention.

FIG. 7 is a cross-sectional view of an alternative embodiment of the integrated recuperator/combustor of the present invention.

### DETAILED DESCRIPTION

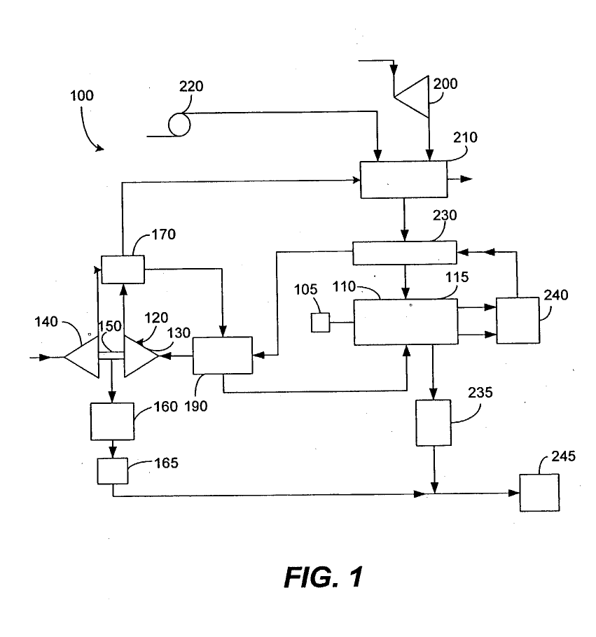

FIG. 1 shows a schematic view of a fuel cell system 100 for use with the present invention. Numerous variations in the overall fuel cell system 100 may be possible herein. In addition to the hybrid system disclosed below, a single cycle system and other known fuel cell systems may be used herein. The invention also may have applicability beyond and in addition to fuel cell applications.

The operation of the fuel cell system 100 and the components therein may be set, monitored, and controlled by a microprocessor 105 or a similar type of control device. Various temperature, load, flow, and/or other types of sensors may be used with the microprocessor 105 or otherwise in the fuel cell system 100.

The fuel cell system 100 may include a stack assembly 110. The stack assembly 110 may include solid oxide fuel cells, molten carbonate fuel cells, and other types of fuel cell designs. The stack assembly 110 may include any number of individual fuel cells. As was described above, the fuel and the oxidant may be fed into the stack assembly 110 to produce electricity in the electrochemical reaction. The electrochemical reaction also produces thermal energy in the form of exhaust heat and spent gases.

Generally described, the fuel cell system 100 may include a fuel cell side 115 with the stack assembly 110 therein and a turbine side 120. The turbine side 120 components may include a turbine 130 and a compressor 140. The turbine 130 may be connected to and drive the compressor 140 via a shaft 150. The turbine 130 and the compressor 140 may be of conventional design. Exhaust gases generated by the stack assembly 110, as will be described in more detail below, may drive the turbine 130. The turbine 130 may be in communication with a generator 160. The mechanical energy of the turbine 130 may be converted to electrical energy in the generator 160. The generator 160 may be of conventional design. An inverter 165 also may be used to convert the direct current produced by the generator 160 to alternating current.

The compressor 140 may compress incoming ambient air. The air may be pressurized to about four (4) atmospheres, although any pressure may be used. The incoming air then may be preheated in a recuperator 170. The recuperator 170 may be in communication with the incoming air stream and the flow of exhaust gases leaving the turbine 130. The recuperator 170 largely acts as a heat exchanger such that the exhaust gases from the turbine 130 may heat the incoming air stream. A fuel cell air preheater 190 then may further heat the incoming air. The fuel cell air preheater 190 may be in communication with the incoming air stream and a flow of exhaust gases from the fuel cell side 115. The fuel cell air preheater 190 also acts largely as a heat exchanger such that the exhaust gases from the fuel cell side 115 may heat the incoming air stream. Heating the air may make the electrochemical reaction in the fuel stack 110 more efficient. After being heated in the air preheater 190, the air may be fed into the stack assembly 110 on the fuel cell side 115.

Due to the high temperature operations in the fuel cell system 110, these heat exchangers may be made of relatively expensive metals. For example, the recuperator 170 and the fuel cell air preheater 190 may be made out of stainless steel, Inconel alloys, or similar types of materials. Inconel alloys are generally nickel-chromium-iron alloys sold by Special Metals of New Hartford, Conn. Other heat exchange devices in the system 100 as a whole also may use similar materials.

Fuel, such as natural gas or similar fuels, may be provided to the stack assembly 110 via a compressor 200. The compressor 200 may be a standard compressor, a fan, or similar type of device. The fuel may be pressurized to about two (2) atmospheres, although any pressure may be used.

The compressor 200 may compress the fuel and forward it onto a gas preheater/steam generator 210. The fuel may be heated within the gas preheater/steam generator 210 via the exhaust gases from the recuperator 170 on the turbine side 120. Other sources of heat also may be used. Heating the fuel also may make the electrochemical reaction in the fuel stack 110 more efficient. The gas preheater/steam generator 210 also may receive a flow of water from a water pump 220. The water may be heated by the gases and turned into steam. The gas preheater/steam generator 210 generally includes at least two (2) separate heat exchangers, one to heat the fuel and one to produce the steam. For example, the gas preheater/steam generator 210 may be made out of stainless steel or similar types of materials.

The fuel then may be fed to a reformer 230. The reformer 230 uses the steam generated within the gas preheater and steam generator 210 for a steam reforming or an autothermal (air and steam) process to convert partially the fuel into a gas containing H₂ and CO. Other types of fuel processing methods and devices may be used.

The reformed fuel stream is then supplied to the stack assembly 110 where the H₂ and CO are electrochemically reacted with oxygen in the incoming air stream to produce electrical power as is described above. An inverter 235 also may be used with the stack assembly 110. The electricity produced by the generator 160 and the stack assembly 110 may be provided to an electrical grid 245 or applied to any type of load.

Any fuel remaining after the electrochemical process then may be oxidized in a stack combustor 240 with the spent airflow. The exhaust heat from the stack combustor 240 may be used to heat the reformer 230. As was described above, the exhaust gases also may be supplied to the fuel cell preheater 190 so as to heat the incoming air stream from the recuperator 170 on its way to the stack assembly 110. The exhaust gases then also may be supplied to the turbine 130.

It is again important to note that the fuel cell system 100 as described above is for purposes of example only. Any type of fuel cell system may be used with the present invention as is described in more detail below.

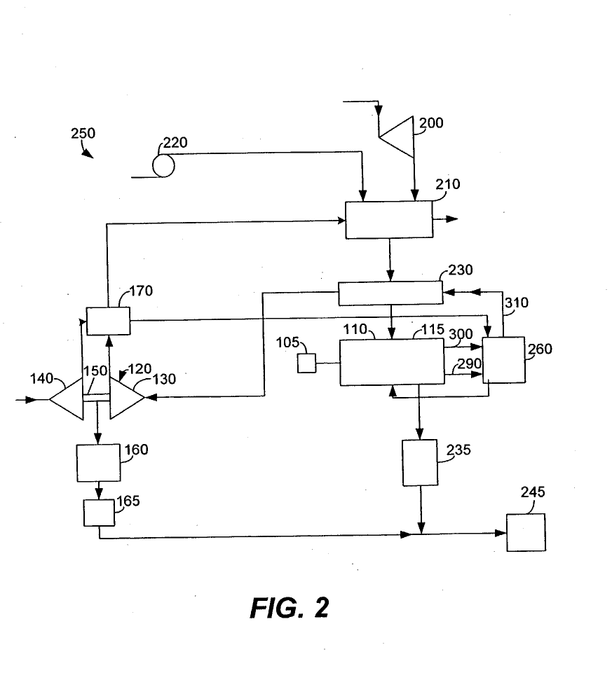

FIG. 2 shows an alternative to the fuel cell system 100, in this case, a fuel cell system 250. In the fuel cell system 250, an integrated recuperator/combustor 260 may be used in place of the fuel cell air preheater 190 and the stack combustor 240. This embodiment also may incorporate the recuperator 170 on the turbine side 120. The present invention may use any combination or orientation of the integrated recuperator/combustor 260, the fuel cell air preheater 190, and the recuperator 170. The incoming air stream thus may travel from the compressor 130 to the recuperator 170 and then to the integrated recuperator/combustor 260. Alternatively, the air may be fed directly from the compressor 130 to the integrated recuperator/combustor 260. The incoming air stream also may travel from the integrated recuperator/combustor 260 and then to the fuel cell air preheater 190. Further, either or both the fuel cell air preheater 190 and/or the recuperator 170 may be eliminated if the integrated recuperator/combustor 260 is used.

The integrated recuperator/combustor 260 also may be used in combination with any other heat exchange device or devices in the fuel cell system 100 as a whole such as the gas preheater/steam generator 210, the reformer 230, or otherwise. Either or both the incoming air or fuel stream may be heated.

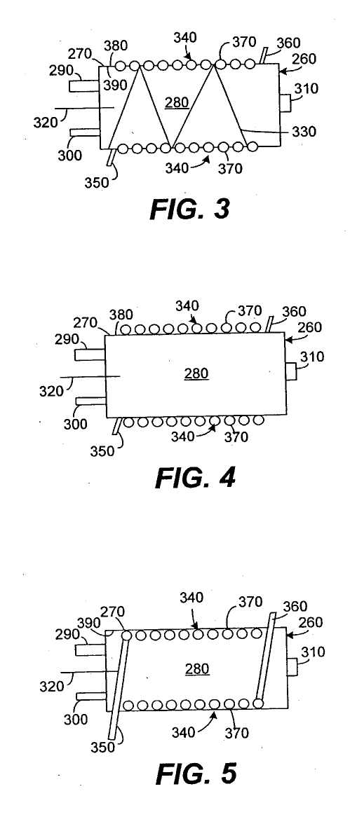

FIG. 3 shows one embodiment of the integrated recuperator/combustor 260. The integrated recuperator/combustor 260 may include an outer shell 270 defining a combustion chamber 280. The outer shell 270 may be made out of stainless steel, Inconel alloys, or similar types of materials. The combustion chamber 280 may include a cathode flow exhaust inlet 290, an anode flow exhaust inlet 300, and an exhaust gas outlet 310. The combustion chamber 280 also may include an igniter 320.

As was described above, spent air from the stack assembly 110 enters via the cathode flow exhaust inlet 290 while spent fuel from the stack assembly 110 enters via the anode flow exhaust inlet 300. The air and the fuel are ignited by the igniter 320 and the exhaust gases exit via the exhaust gas outlet 310. The combustion chamber 280 also may include a turbulator 330 surrounding the inner wall of the combustion chamber 280 so as to insure proper turbulence in the air and fuel flow and to promote combustion.

The integrated recuperator/combustor 260 also may include a recuperator 340. The recuperator 340 may include a compressor input 350 and a stack output 360. The compressor input 350 and the stack output 360 may be separated by a recuperator tube 370. The recuperator tube 370 may form one or more spiral paths about the outer shell 270. Any other type or number of pathways also may be used. The recuperator tube 370 may be made out of stainless steel, Inconel alloys, or similar types of materials with good heat transfer characteristics. As is shown in FIG. 3, the outer shell 270 may define an exterior wall 380 and an interior wall 390. The recuperator tube 370 may be positioned on or within the exterior wall 380. The outer shell 270 may define a channel 375 therein for the positioning of the recuperator tube 370. Specifically, the recuperator tube 370 may be welded or brazed to the exterior wall 380. Similar types of attachment means also may be used.

FIGS. 4-6 show various alternative embodiments of the recuperator 340. In FIG. 4, the recuperator tube 370 may be positioned on the exterior wall 380 of the outer shell 270. The recuperator tube 370 may be attached by welding, brazing, or similar methods. The configurations shown in FIGS. 3 and 4 use both conduction and radiation modes of heat transfer. The configuration of FIG. 3 may provide a more efficient path for conduction given the positioning of the recuperator tube 370 within the channel 375 of the outer shell 270.

FIG. 5 shows the recuperator tube 370 positioned within the outer shell 270 along the interior wall 390. The recuperator tube 370 may be attached by welding, brazing, or similar methods. The configuration of FIG. 5 thus uses three modes of heat transfer, namely conduction, convection, and radiation. In this configuration, the input and output 350, 360 should be tightly sealed to avoid any leaks from the combustion chamber 280.

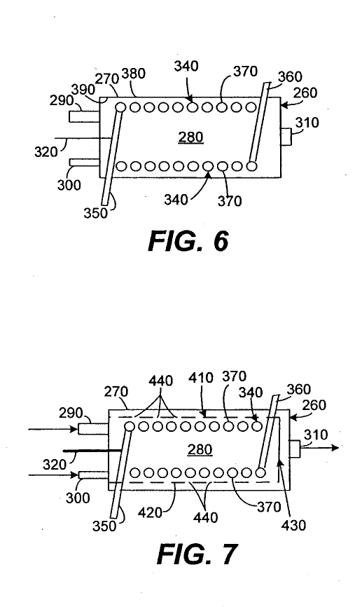

FIG. 6 shows the recuperation tube 370 positioned within the combustion chamber 280 of the outer shell 270 but not in contact with the interior wall 390. The configuration provides effective convective heat transfer but no conduction. There also is no need for welding or brazing in this configuration.

In use, air from the compressor 130 may be sent to the integrated recuperator/combustor 260. The air enters via the compressor input 350 into the recuperator tube 370. While in the recuperator tube 370, the air is heated via conduction, convention, and/or radiation depending upon the configuration of the recuperation tube 370. The heated air then exists via the stack output 360 and travels to the fuel cell stack 110. The electrochemical reaction then takes place within the fuel cell stack 110. The spent fuel and air exits the fuel cell stack 110 and enters the integrated recuperator/combustor 260 via the cathode flow exhaust inlet 290 and the anode flow exhaust inlet 300. The air and the fuel are ignited by the igniter 320 so as to heat the incoming air within the recuperator tube 370. The exhaust gas exits the integrated recuperator combustor 260 via the exhaust gas outlet 310 and travels to the reformer 230 or elsewhere. As described above, the present invention also may use any combination or orientation of the integrated recuperator/combustor 260, the fuel cell air preheater 190, and the recuperator 170, and/or any other heat exchange structure within the fuel cell system 100 as a whole.

The present invention thus provides improved reliability, maintainability, and lower costs in that two separate fuel cell system components may be combined and improved. The present invention thus improves the efficiency of the air preheating process in specific and the efficiency of the fuel cell system 100 as a whole.

FIG. 7 shows a further embodiment of an integrated recuperator/combustor 400. The integrated recuperator/combustor 400 may include the outer shell 270 defining the combustion chamber 280. The outer shell 270 maybe made out of stainless steel, Inconel alloys, or similar types of materials. The combustion chamber 280 may include the cathode flow exhaust inlet 290, the anode flow exhaust inlet 300, and the exhaust gas outlet 310. The combustion chamber 280 also may include the igniter 320.

Positioned within the outer shell 270 of the integrated recuperator/combustor 400 may be an inner shell 410. The inner shell 410 may be made out of stainless steel, Inconel alloys, or similar types of materials. The inner shell 410 may include an elongated, substantially tubular side wall 420 that ends in a solid end wall 430. The side wall 420 may have a number of apertures or perforations 440 positioned therein. The inner shell 410 may be spaced about one (1) to about ten (10) centimeters from the outer shell 270, although any spacing may be used.

The integrated recuperator/combustor 400 also may include the recuperator 340. The recuperator 340 may include the compressor outlet 350 and the stack outlet 360. The compressor input 350 and the stack output 360 may be separated by the recuperator tube 370. The recuperator tube 370 may be made out of stainless steel, Inconel alloys, or similar types of materials with good heat transfer characteristics.

The recuperator tube 370 may be placed inside the side wall 420 of the inner shell 410, although the recuperator tube 370 also may be placed within or outside the side wall and/or otherwise about the inner shell 410. The recuperator tube 370 may form one or more spiral paths about the inner shell 410. Any other type or number of pathways also may be used. The recuperator tube 370 may be within the inner shell 410 or the tube 370 may be welded or brazed to the inner shell 410. Similar types of attachment means also may be used.

In use, the cathode flow exhaust and the anode flow exhaust are ignited within the combustion chamber 280 via the igniter 320 as described above. Because of the solid end wall 430, the gases are forced to flow radially over the recuperator tube 370 and exit the inner shell 410 via the perforations 440 within the side wall 420. This forced flow path provides for good heat transfer with the recuperator tube 370. The exhaust gases then exit via the exhaust gas outlet 310. The gases are collected within the outer shell 270 and flow towards the exhaust gas outlet 310. The exhaust gases then may be used in further heat exchangers.

It should be apparent that the foregoing relates only to the preferred embodiments of the present invention and that numerous changes and modifications may be made herein without departing from the spirit and scope of the invention as defined by the following claims and the equivalents thereof.

1. A fuel cell system for converting a first flow and a second flow to electricity, a first spent flow, and a second spent flow, comprising:
a chamber for combusting the first spent flow and the second spent flow to produce heat; and
a pathway for the first flow;
the pathway positioned about the chamber for heat exchange therewith.

2. The fuel cell system of claim 1, wherein the first flow comprises a flow of oxidant and the first spent flow comprises a flow of spent oxidant.

3. The fuel cell system of claim 1, wherein the first flow comprises a flow of fuel and the first spent flow comprises a flow of spent fuel.

4. The fuel cell system of claim 1, wherein the chamber comprises a combustor.

5. The fuel cell system of claim 1, wherein the pathway comprises a recuperator.

6. The fuel cell system of claim 1, wherein the pathway comprises an air preheater.

7. The fuel cell system of claim 1, wherein the pathway comprises a fuel preheater.

8. The fuel cell system of claim 1, wherein the pathway comprises a reformer.

9. The fuel cell system of claim 1, wherein the pathway comprises a steam generator.

10. The fuel cell system of claim 1, further comprising a second heat exchanger in communication with the pathway.

11. The fuel cell system of claim 1, wherein the chamber comprises an igniter positioned therein.

12. The fuel cell system of claim 1, wherein the chamber comprises an inner surface and an outer surface.

13. The fuel cell system of claim 12, wherein the pathway is positioned on the outer surface of the chamber.

14. The fuel cell system of claim 12, wherein the pathway is positioned on the inner surface of the chamber.

15. The fuel cell system of claim 12, wherein the pathway is positioned within the chamber.

16. The fuel cell system of claim 1, wherein the chamber comprises an inner chamber and an outer chamber.

17. The fuel cell system of claim 16, wherein the inner chamber comprises a side wall and an end wall and wherein the side wall comprises a plurality of apertures therein.

18. The fuel cell system of claim 17, wherein the pathway is positioned about the inner chamber.

19. The fuel cell system of claim 18, wherein the pathway is positioned inside the inner chamber.

20. The fuel cell system of claim 1, wherein the pathway comprises one or more pathways.

21. A fuel cell system for converting a flow of fuel and a flow of oxidant to electricity, a spent fuel flow, and a spent gas flow, comprising:
a chamber for combusting the spent fuel flow and the spent oxidant flow to produce heat; and
a pathway for the flow of oxidant;
the pathway positioned about the chamber for heat exchange between the heat produced in the chamber and the flow of oxidant in the pathway.

22. The fuel cell system of claim 21, wherein the chamber comprises an inner surface and an outer surface.

23. The fuel cell system of claim 22, wherein the pathway is positioned on the outer surface of the chamber.

24. The fuel cell system of claim 22, wherein the pathway is positioned on the inner surface of the chamber.

25. The fuel cell system of claim 22, wherein the pathway is positioned within the chamber.

26. The fuel cell system of claim 21, wherein the chamber comprises an inner chamber and an outer chamber.

27. The fuel cell system of claim 26, wherein the inner chamber comprises a side wall and an end wall and wherein the side wall comprises a plurality of apertures therein.

28. A fuel cell system for converting a first flow and a second flow to electricity, a first spent flow, and a second spent flow, comprising:
an inner chamber for combusting the first spent flow and the second spent flow to produce heated exhaust gases;
the inner chamber comprising a side wall and an end wall and wherein the side wall comprises a plurality of apertures therein for the heated exhaust gases to flow therethrough;
a pathway for the first flow;
the pathway positioned about the inner chamber for heat exchange with the heated exhaust gases; and
an outer chamber to direct the flow of the heated exhaust gases.

29. A method for heating a flow of oxidant to be used in a fuel cell system producing electricity, a spent fuel flow, and a spent gas flow, comprising:
combusting the spent fuel flow and the spent oxidant flow to produce heat;
surrounding the combustion with the flow of oxidant; and
heating the flow of oxidant.
